(19) United States
(12) Patent Application Publication
(10) Pub. No.: US 2026/0249613 A1
(43) Pub. Date: Aug. 27, 2026

(54) METHOD OF MANUFACTURING LIQUID DISCHARGE HEAD, AND LIQUID DISCHARGE HEAD

(71) Applicant: CANON KABUSHIKI KAISHA, Tokyo (JP)

(72) Inventors: RYOTARO MURAKAMI, Kanagawa (JP); ATSUNORI TERASAKI, Kanagawa (JP)

(21) Appl. No.: 19/393,821

(22) Filed: Nov. 19, 2025

(30) Foreign Application Priority Data
Dec. 10, 2024 (JP) 2024-215846

(51) Int. Cl. B41J 2/16

(52) U.S. Cl. CPC B41J 2/1642; B41J 2/1623; B41J 2/1629; B41J 2/1645; B41J 2/1601; B41J 2/1607

(57) ABSTRACT

A method of manufacturing a liquid discharge head includes: (a) a first substrate preparing step of providing an energy generating element on a first surface and forming a first flow path; (b) a second substrate preparing step of forming a second flow path; (c) a first film forming step of forming a first protective film; (d) a first ashing step of ashing a second surface; (e) a second film forming step of forming a second protective film covering a second surface; (f) a bonding step of bonding a first flow-path substrate and a second flow-path substrate; (g) a second ashing step of ashing the first surface; and (h) a hydrofluoric acid processing step of processing the first surface with hydrofluoric acid. The second film forming step, the bonding step, the second ashing step, and the hydrofluoric acid processing step are performed in this order.

### BACKGROUND

### Field of the Technology

This disclosure relates to a method of manufacturing a liquid discharge head substrate, and a liquid discharge head.

### Description of the Related Art

As a liquid discharge head for discharging a liquid such as ink, there is known a configuration comprising nozzles and a liquid discharge head substrate formed with flow paths communicating with the nozzles. In the liquid discharge head substrate of such a configuration, a protective film may be provided for protecting the surface of the substrate and the flow paths.

Japanese Patent Application laid-open No. 2020-97129 discloses a configuration in which a liquid-resistant protective film is provided to cover a predetermined portion of the substrate as a protective film for protecting the surface of the substrate and flow paths. In particular, in the case where the substrate is a silicon substrate, since the inner wall surface of the flow path is liable to be eroded by ink, it is important to provide such a protective film.

When a liquid discharge head substrate is configured by bonding a plurality of substrates, another protective film may be further provided on the protective film for the purpose of improving the adhesion of the substrate. However, in a film forming step of these protective films, the protective film may be formed on unintended portions, or unintended components may remain on the surface of the substrate when the protective film is removed, resulting in a decrease in the reliability of the liquid discharge head substrate.

### SUMMARY

This disclosure has been made in view of the above-mentioned problems, and has an object of providing a liquid discharge head with high reliability.

To achieve the object described above, a manufacturing method of a liquid discharge head according to this disclosure is
a method of manufacturing a liquid discharge head configured by a first flow-path substrate and a second flow-path substrate, the method comprising:
(a) a first substrate preparing step of providing an energy generating element for generating energy for discharging a liquid on a first surface of the first flow-path substrate and of forming a first flow path passing through from the first surface to a second surface opposite to the first surface in the first flow-path substrate;
(b) a second substrate preparing step of forming a second flow path passing through the second flow-path substrate from a third surface to a fourth surface opposite to the third surface;
(c) a first film forming step of forming a first protective film covering at least a part of the first surface of the first flow-path substrate and a wall surface of the first flow path;
(d) a first ashing step of ashing the second surface of the first flow-path substrate;
(e) a second film forming step of forming a second protective film covering the second surface of the first flow-path substrate; and
(f) a bonding step of bonding the second surface of the first flow-path substrate and the third surface of the second flow-path substrate via an adhesive such that the first flow path and the second flow path communicate with each other;
(g) a second ashing step of ashing the first surface of the first flow-path substrate; and
(h) a hydrofluoric acid processing step of processing the first surface of the first flow-path substrate with hydrofluoric acid, wherein,
the second film forming step, the bonding step, the second ashing step, and the hydrofluoric acid processing step are performed in this order.

According to another aspect, a method of manufacturing a liquid discharge head according to this disclosure is
a method of manufacturing a liquid discharge head configured by a first flow-path substrate and a second flow-path substrate, the method comprising:
(a) a first substrate preparing step of providing the energy generating element on a first surface of the first flow-path substrate for generating energy for discharging a liquid;
(b) a first film forming step of forming a first protective film covering at least a part of the first surface of the first flow-path substrate and a wall surface of the first flow path;
(c) a second film forming step of forming a second protective film covering the second surface of the first flow-path substrate;
(d) a bonding step of bonding a second surface of the first flow-path substrate opposite to the first surface to a third surface of the second flow-path substrate via an adhesive; and
(e) a first film removing step of removing at least a part of the first protective film provided on the first surface of the first flow-path substrate, wherein,
the second film forming step and the first film removing step are performed in this order.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic exploded perspective view of a liquid discharge head.

FIG. 2 is a schematic cross-sectional diagram of the liquid discharge head substrate according to a First Embodiment.

FIG. 3A is a schematic cross-sectional diagram of a first flow-path substrate after forming of a first protective film.

FIG. 3B is a schematic cross-sectional diagram of the first flow-path substrate from which a part of the first protective film was removed.

FIG. 3C is a schematic cross-sectional diagram of the first flow-path substrate that has been ashed.

FIG. 3D is a schematic cross-sectional diagram of the first flow-path substrate after the forming of a second protective film.

FIG. 3E is a schematic cross-sectional diagram of the substrate after the bonding step.

FIG. 3F is a schematic cross-sectional diagram of an ashed substrate.

FIG. 3G is a schematic cross-sectional diagram of the substrate from which the second protective film was removed.

FIG. 4A is a schematic cross-sectional diagram of the first flow-path substrate after the forming of the first protective film.

FIG. 4B is a schematic cross-sectional diagram of the first flow-path substrate after the forming of the second protective film.

FIG. 4C is a schematic cross-sectional diagram of the substrate after the bonding step.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

### First Embodiment

A liquid discharge head 10 of the First Embodiment according to this disclosure and a recording device including the liquid discharge head 10 will be explained. The recording device comprises a carrier portion for carrying a recording medium, and the liquid discharge head 10 for discharging liquid toward the recording medium carried by the carrier portion. The liquid discharge head 10 is an ink-jet type recording head that records an image onto the recording medium by discharging ink as a liquid.

### Configuration of Liquid Discharge Head

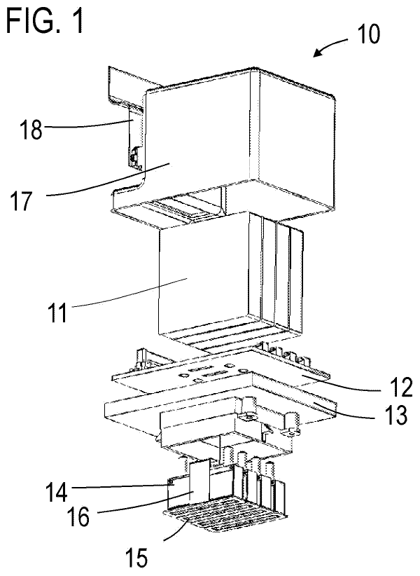

A configuration of a liquid discharge head 10 according to the First Embodiment will be described with reference to FIG. 1. FIG. 1 is a schematic exploded perspective view of the liquid discharge head 10. The liquid discharge head 10 includes a sub-tank unit 11, an electric circuit substrate 12, a base member 13, a flow path unit 14, a recording element substrate 15, an electric wiring member 16, a cover 17, and an electrical connection member 18.

The recording element substrate 15 is constituted by connecting a liquid discharge head substrate 100 and a pitch converting member, and is formed with a flow path through which the liquid supplied from the sub-tank unit 11 flows. In the recording element substrate 15, a discharge port array constituted by aligning a plurality of discharge ports is provided. The flow path unit 14 includes a reservoir for storing liquid and the like, and supplies liquid supplied from the sub-tank unit 11 to the recording element substrate 15.

The sub-tank unit 11 stores therein a liquid supplied from the outside of the liquid discharge head 10 to be used for image recording. The sub-tank unit 11 has a pressure adjusting mechanism, and also has a function of controlling the pressure in the flow path of the liquid discharge head 10. Further, the sub-tank unit 11 may have a circulating unit for circulating the liquid between the sub-tank unit 11 and the recording element substrate 15. The cover 17 is mounted on the sub-tank unit 11, and the sub-tank unit 11 is covered and protected with the cover 17.

The electric circuit substrate 12 receives a signal for driving the recording element substrate 15 from a signal transmitting portion provided in a main body of the recording device. The electric circuit substrate 12 is connected to the signal transmission portion of the recording device via the electrical connection member 18, and receives from the recording device a signal for driving the energy generating elements provided, for example, on the recording element substrate 15. The electrical connection member 18 is a member for electrically connecting the main body of the recording device and the liquid discharge head 10, and is, for example, a flexible cable.

The electric wiring member 16 electrically connects the electric circuit substrate 12 and the recording element substrate 15. Signals received by the electric circuit substrate 12 are transmitted to the recording element substrate 15 via the electric wiring member 16.

The base member 13 is a support member for supporting the flow path unit 14. The flow path unit 14 is fixed to the base member 13 by, for example, an adhesive. Further, the base member 13 includes a cover (not shown) for protecting the flow path unit 14 and the recording element substrate 15 connected to the flow path unit 14 from the outside.

FIG. 1 shows the liquid discharge head 10 in which four flow path units 14 and the recording element substrates 15 are disposed side by side. However, in applying this disclosure, the liquid discharge head 10 may be constructed by disposing less than four or five or more flow path units 14 and recording element substrates 15 side by side.

### Configuration of Liquid Discharge Head Substrate

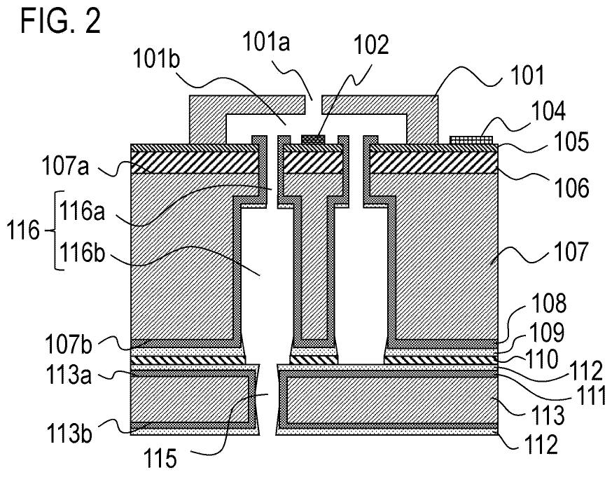

A configuration of the liquid discharge head substrate 100 according to a First Embodiment will be explained with reference to FIG. 2. FIG. 2 is a schematic cross-sectional diagram of the liquid discharge head substrate 100 according to the First Embodiment. In the liquid discharge head substrate 100, a plurality of nozzles 101a are formed as discharge ports for discharging liquid. FIG. 2 shows a section of a part of the liquid discharge head substrate 100, and shows one nozzle 101a of the liquid discharge head substrate 100 and a flow path communicating with the nozzle 101a.

The liquid discharge head substrate 100 is constituted by a first flow-path substrate 107 and a second flow-path substrate 113.

The first flow-path substrate 107 includes a first surface 107a and a second surface 107b opposite to the first surface 107a. On the first surface 107a, a wiring layer 106 and a protective layer 105 for protecting the wiring layer 106 are laminated in this order. Further, in the first flow-path substrate 107, a nozzle forming member 101 (discharge-port forming member) in which the nozzle 101a is formed, an energy generating element 102 for generating energy for discharging the liquid, and an electrical connection portion 104 are provided. The nozzle forming member 101, the energy generating element 102, and the electrical connection portion 104 are all provided on the first surface 107a side, that is, on the protective layer 105. The energy generating element 102 and the electrical connection portion 104 are electrically connected to each other via the wiring layer 106. It is to be noted that, in this specification, a member or a film is provided on the surface of the substrate not only in the case where the member or film is in direct contact with the surface of the substrate but also in the case where the member or film is provided on the surface of the substrate via another film or layer.

In the nozzle forming member 101, the nozzle 101a and a nozzle flow path 101b communicating with the nozzle 101a are formed. The nozzle flow path 101b is a pressure chamber in which the energy generating element 102 is provided. When viewed in a direction orthogonal to the first surface 107a, the nozzle 101a and the energy generating element 102 is disposed at a position which overlaps each other, and the liquid is discharged from the nozzle 101a in a direction perpendicular to the first surface 107a. The energy generating element 102 may be an element such as a heater element for heating/boiling a liquid, or an element for applying pressure to a liquid by utilizing a volume change, such as a piezoelectric element.

A first flow path 116 passing through from the first surface 107a to the second surface 107b is formed inside the first flow-path substrate 107. The first flow path 116 includes an individual flow path 116a that opens in the first surface 107a and communicates with the nozzle flow path 101b, and a common liquid chamber 116b (common flow path) that opens in the second surface 107b and communicates with the flow path in the second flow-path substrate 113 and the individual flow path 116a. In the first flow-path substrate 107, a plurality of the individual flow paths 116a and a plurality of common liquid chambers 116b are provided. A plurality of the individual flow paths 116a may communicate with a single unit of the common liquid chamber 116b, or a single unit of the common liquid chamber 116b may communicate with a single unit of the individual flow path 116a.

A first protective film 108 and a second protective film 109 are formed on the first flow-path substrate 107. The first protective film 108 and the second protective film 109 are formed on the first flow-path substrate 107 in this order.

The first protective film 108 is a protective film provided for protecting the first flow-path substrate 107 with liquid such as ink as a main purpose. The first protective film 108 is provided so as to cover at least the second surface 107b of the first flow-path substrate 107 and the first flow path 116. On the other hand, the first protective film 108 is not provided on the region of the first surface 107a (protective layer 105) where the nozzle forming member 101, the energy generating element 102 and the electrical connection portion 104 are to be provided. Further, the first protective film 108 does not cover the nozzle forming member 101, the energy generating element 102 and the electrical connection portion 104 themselves.

The second protective film 109 is a protective film (adhesion film) provided for protecting the first flow-path substrate 107 and improving the adhesion between the first flow-path substrate 107 and the second flow-path substrate 113 as a main purpose. The second protective film 109 is provided so as to cover at least the second surface 107b of the first flow-path substrate 107.

The second flow-path substrate 113 includes a third surface 113a bonded to the second surface 107b of the first flow-path substrate 107, and a fourth surface 113b which is a surface opposite to the third surface 113a. The second surface 107b of the first flow-path substrate 107 and the third surface 113a of the second flow-path substrate 113 are bonded by an adhesive 110. Further, the fourth surface 113b is a bonding surface that is bonded to a pitch converting member.

A second flow path 115 passing through from the third surface 113a to the fourth surface 113b is formed inside the second flow-path substrate 113. The second flow path 115 communicates with the common liquid chamber 116b of the first flow path 116. In the second flow-path substrate 113, a plurality of second flow paths 115 are formed.

A first protective film 111 and a second protective film 112 are formed on the second flow-path substrate 113. The first protective film 111 and the second protective film 112 are formed on the second flow-path substrate 113 in this order. The first protective film 111 has a function similar to that of the first protective film 108 provided on the first flow-path substrate 107. The first protective film 111 is provided so as to cover the third surface 113a, the fourth surface 113b, and the second flow path 115. The second protective film 112 has a function similar to that of the second protective film 109 provided on the first flow-path substrate 107. The second protective film 112 is provided so as to cover the third surface 113a and the fourth surface 113b.

Due to the configuration as above, a flow path is formed inside the liquid discharge head substrate 100 for allowing the liquid supplied from the sub-tank unit 11 to flow therethrough. In the First Embodiment, the flow path of the liquid discharge head substrate 100 is constituted by including the nozzle flow path 101b, the first flow path 116, and the second flow path 115. The liquid passes through the second flow path 115, the first flow path 116, and the nozzle flow path 101b in this order, and is discharged from the nozzle 101a. Further, in a case of a configuration in which the liquid is circulated, the liquid which has not been discharged from the nozzle 101a is recovered into the sub-tank unit 11 through the other first flow path 116 and the second flow path 115.

As described above, the first protective film 108 and the second protective film 109 are formed on the first flow-path substrate 107 which constitutes the liquid discharge head substrate 100. At this time, the first protective film 108 is patterned (removed) so as not to cover the portions on the first surface 107a of the first flow-path substrate 107, on which the nozzle forming member 101 is provided, the energy generating element 102, and the like. And, as the forming of the second protective film 109, a case where it is performed before the patterning of the first protective film 108 and a case where it is performed thereafter can be considered.

Assume that the first protective film 108 is formed, and then the second protective film 109 is formed before patterning the first protective film 108. In this case, there is a concern that organic components such as a resist or a stripper applied when the first protective film 108 is patterned may remain on the second protective film 109 and contaminate the second protective film 109. Then, the adhesion of the second protective film 109 deteriorates. On the other hand, when an oxygen plasma processing, for example, is performed to remove organic components, there is a concern that the second protective film 109 is deteriorated in quality to lower the adhesion.

Assume that the first protective film 108 is formed and then, the second protective film 109 is formed after patterning of the first protective film 108. In this case, the second protective film 109 is formed also on the first surface 107a via the first flow path 116. The first surface 107a is a device forming surface on which devices such as the energy generating element 102 and the electrical connection portion 104 are formed. Therefore, due to the forming of the second protective film 109 on the first surface 107a, there is a concern that the device characteristics and electric characteristics cannot exert desired performance.

Hereinafter, as a method of manufacturing the liquid discharge head substrate 100 according to the First Embodiment, a method of manufacturing a liquid discharge head substrate 100 which can suppress the deterioration in adhesion and performance and has high reliability will be described.

### Method of Manufacturing Liquid Discharge Head Substrate

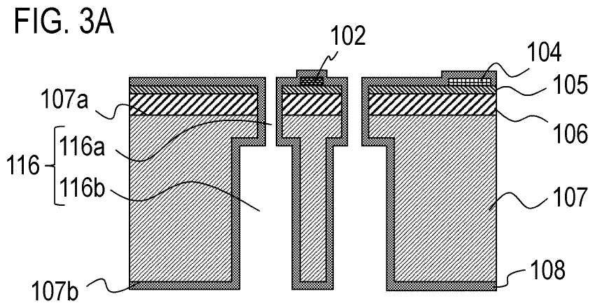

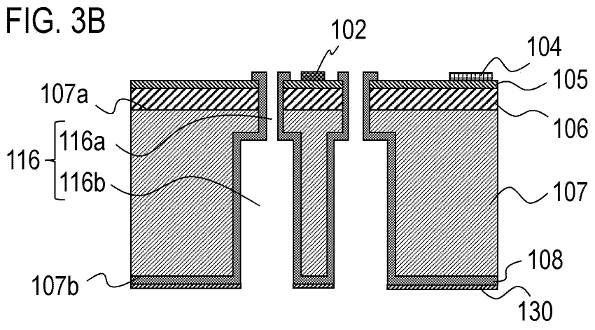

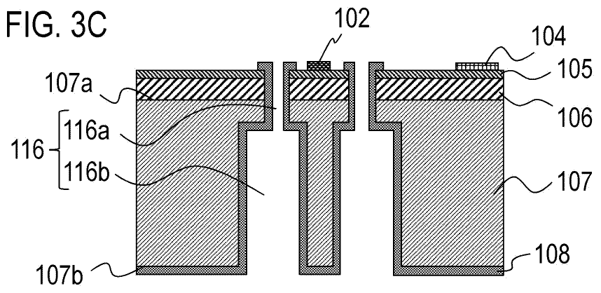

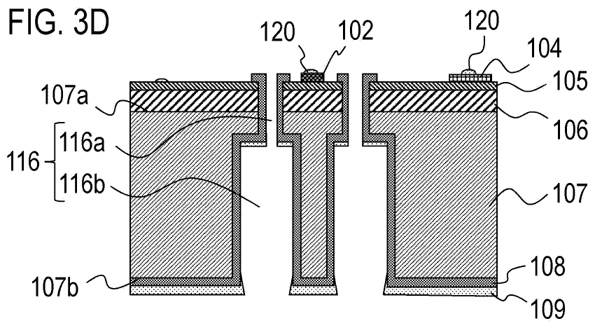

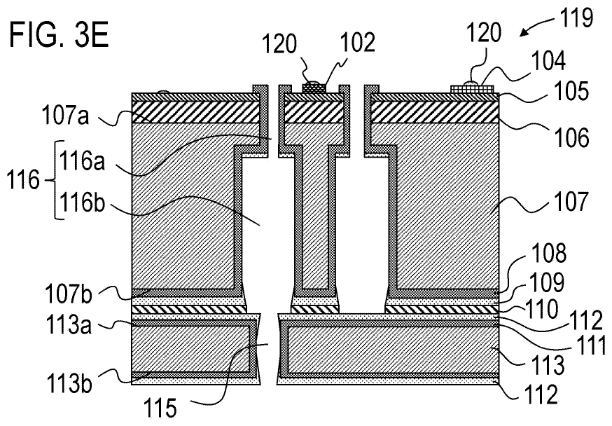

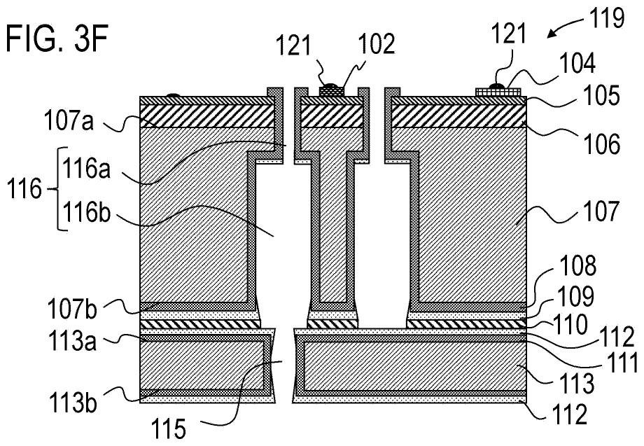

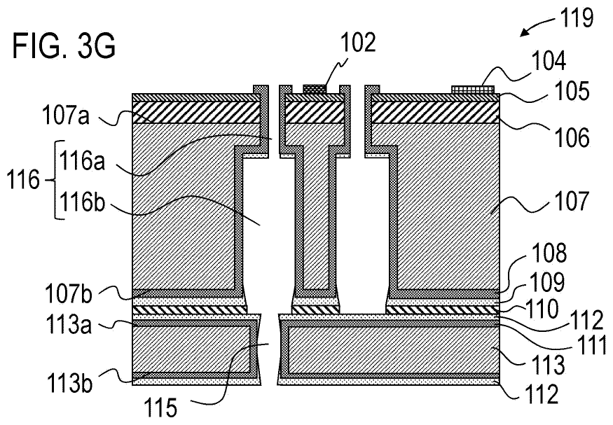

A manufacturing method of a liquid discharge head substrate 100 according to the First Embodiment will be described in an exemplary manner with reference to FIGS. 3A to 3G. FIGS. 3A to 3G are explanatory diagrams of a method of manufacturing the liquid discharge head substrate 100, and are schematic cross-sectional diagrams in a similar cross-section to FIG. 2.

First, the wiring layer 106 and the protective layer 105 are laminated in this order on the first surface 107a of the first flow-path substrate 107. And the energy generating elements 102 and the electrical connection portion 104 are provided on the first surface 107a, and the first flow path 116 is formed in the first flow-path substrate 107. These steps are combined into a first substrate preparing step. It is to be noted that, in the First Embodiment, the first flow-path substrate 107 is a silicon substrate and is formed by using a silicon wafer.

The first flow paths 116 (the individual flow paths 116a and the common liquid chamber 116b) are formed by the Bosch process, which is a kind of reactive ion etching. The Bosch process is a technique of forming an etched groove perpendicular to a substrate by alternately performing coating and etching. Further, it is also possible to adopt a method of forming a non-through hole and then causing the substrate to pierce by reducing the thickness thereof by back-grinding or CMP.

Subsequently, the first film forming step is performed for forming the first protective film 108 on the first flow-path substrate 107 prepared in the first substrate preparing step. FIG. 3A shows the first flow-path substrate 107 after the forming of the first protective film 108. It is preferable that the first protective film 108 is formed so as to cover the entire silicon surface (surface on which nothing is laminated) of the first flow-path substrate 107 including at least the wall surface of the first flow path 116. In the first film forming step, the first protective film 108 is formed so as to cover the wall surfaces of the energy generating elements 102 and the electrical connection portion 104, the first flow path 116 and the entire surface of the first flow-path substrate 107 on the first surface 107a.

As the first protective film 108, it is formed by including an oxide of at least one metal selected from the group consisting of Ti, Zr, Hf, V, Nb, Ta, and the like, for example, and more preferably, it is formed of TiO (titanium oxide).

As a method of forming the first protective film, a film forming method such as a Chemical Vapor Deposition (CVD) method, a sputtering method, or an Atomic Layer Deposition (ALD) method can be employed. Among them, the ALD method having a good turn around characteristic is preferable. Depending on the structure of the exposed flow-path surface, these film forming methods may be selected.

Subsequently, a first film removing step of partially removing the first protective film 108 on the first surface 107a is performed. More specifically, the first protective film 108 is removed from the region of the first surface 107a where the energy generating element 102 and the electrical connection portion 104 are formed and the region where the nozzle forming member 101 will be formed later. FIG. 3B shows the first flow-path substrate 107 from which a part of the first protective film 108 is removed. In the First Embodiment, as viewed in the direction perpendicular to the first surface 107a, the first protective film 108 on the first surface 107a is removed at least in the region overlapping the energy generating elements 102 and the electrical connection portion 104 and in the region where the nozzle forming member 101 is provided (contacted).

The first protective film 108 may be formed by forming a resist on the first surface 107a, exposing a removal portion via photolithography steps including exposure and development, and thereafter removing the resist by wet etching or dry etching. Then, the resist which has become unnecessary is removed by an organic peeling solution. It is to be noted that the step of partial removing of the first protective film 108 (first film removing step) may be regarded as a step of the first film forming step. After performing the first film forming step, an organic contaminant 130 may remain on the first protective film 108 on the second surface 107b opposite to the first surface 107a.

Subsequently, the first ashing step is performed on the first flow-path substrate 107. The first ashing step is performed for the removal of the organic contaminants 130 on the second surface 107b. FIG. 3C shows the first flow-path substrate 107 that has been ashed. The ashing is such a method that oxygen plasmas are generated, oxygen radicals are caused to react with organic substances, and the organic substances are decomposed into CO₂ and H₂O and vaporized, thereby removing the organic substances.

When TiO is film-formed as the first protective film 108 by using TiCl₄ by the ALD method, the chlorine component contained in the precursor may be contained in the formed TiO. When chlorine reacts with the ink component, the reliability of adhesion at the bonded interface is lowered. Thus, it is possible to reduce the chlorine composition ratio in TiO and to improve adhesion reliability by ashing the second surface 107b. A preferable chlorine composition ratio in TiO is 1% or less.

Subsequently, the second film forming step in which the second protective film 109 is formed on the first flow-path substrate 107 is performed. FIG. 3D shows the first flow-path substrate 107 after the second protective film 109 is formed. The second protective film 109 is formed on the second surface 107b of the first flow-path substrate 107 and on the first protective film 108.

As the second protective film 109, the selection is made from a group consisting of an SiC film, an SiCN film, an SiOC film, an SiOCN film, or the like, for example, and an SiC film is more preferable. That is, the second protective film 109 is formed by including at least any one of SiC, SiCN, SiOC and SiOCN.

As the method of forming the second protective film 109, a method similar to the method of forming the first protective film 108 can be cited. In order to selectively form a film on the second surface 107b, a chemical vapor deposition (CVD) method or a sputtering method is particularly preferable, and a chemical vapor deposition (CVD) method is more preferable.

When the second protective film 109 is formed, the first flow path 116 passes through the first flow-path substrate 107 from the first surface 107a to the second surface 107b. Therefore, in the second film forming step, the gas flows to the first surface 107a side through the first flow paths 116 which are through-holes, and the second protective film is formed even slightly on the first surface 107a of the first flow-path substrate 107. As described above, the second protective film unintentionally formed on the first surface 107a is assumed to be a second protective film 120 by distinction from the second protective film 109 on the second surface 107b. Since the energy generating element 102 and the electrical connection portion 104 are formed on the first surface 107a, there is a concern that the device characteristic and the electrical characteristics may be affected if, for example, the second protective film 120 is formed thereon.

A second substrate preparing step for forming the second flow-path substrate 113, the first film forming step, the second film forming step are performed in parallel with the first substrate preparing step for forming the first flow-path substrate 107, the first film forming step, the first ashing step, and the second film forming step. However, the forming of the first flow-path substrate 107 and the forming of the second flow-path substrate 113 may be performed in order, and the order thereof is not limited. In the First Embodiment, the second flow-path substrate 113 is a silicon substrate similarly to the first flow-path substrate 107 and is formed by using a silicon wafer.

The second substrate preparing step is a step in which the second flow path 115 is formed in the second flow-path substrate 113. The forming of the second flow path 115 can be performed similarly to the forming of the first flow path 116. The first film forming step is a step in which the first protective film 111 is formed on the second flow-path substrate 113. The film forming of the first protective film 111 can be performed similarly to the film forming of the first protective film 108. The second film forming step is a step in which the second protective film 112 is formed on the second flow-path substrate 113. The film forming of the second protective film 112 can be performed similarly to the second protective film 109. Further, after the first film forming step, the first ashing step may be performed similarly to the first flow-path substrate 107. However, various kinds of films, film forming methods, and forming methods of flow paths do not necessarily have to be the same as those of the first flow-path substrate 107, and they may be different between the first flow-path substrate 107 and the second flow-path substrate 113 so as to obtain desired performances.

Subsequently, the bonding step of bonding the first flow-path substrate 107 and the second flow-path substrate 113 is performed. For convenience, a substrate formed by bonding the second surface 107b of the first flow-path substrate 107 and the third surface 113a of the second flow-path substrate 113 is referred to as a substrate 119. FIG. 3E shows the substrate 119 after the bonding step.

The bonding between the first flow-path substrate 107 and the second flow-path substrate 113 is performed by the adhesive 110. The adhesive 110 is formed (applied) on the second protective film 109 on the second surface 107b of the first flow-path substrate 107 or on the second protective film 109 on the third surface 113a of the second flow-path substrate 113. FIG. 3E shows an example in which the adhesive 110 is formed on the first flow-path substrate 107. Then, the second surface 107b and the third surface 113a are bonded to each other via the adhesive 110 such that the first flow path 116 and the second flow path 115 communicate with each other.

As the adhesive 110, a material with a high applicability with little mixing of bubbles or the like is preferable, and a material with a low viscosity that easily makes the thickness of the adhesive 110 thin is preferable. It is preferable that the adhesive 110 includes any one of resins selected from a group constituted by an epoxy resin, an acrylic resin, a silicon resin, a benzocyclobutene resin, a polyamide resin, a polyimide resin, and a urethane resin. As a curing method of the adhesive 110, for example, a heat curing method and an ultraviolet delay curing method can be used. It is to be noted that, if any one of the substrates has ultraviolet transmittance, the ultraviolet curing system can also be used.

As a method of applying the adhesive 110, for example, an adhesive transfer method using a base material for transfer can be used. Specifically, a base material for transfer is prepared, and the adhesive 110 is applied thinly and uniformly on the base material for transfer by spin coating or slit coating. Thereafter, an adhesion surface (the second surface 107b) of the first flow-path substrate 107 is brought into contact with the applied adhesive 110, whereby the adhesive 110 can be transferred only to the adhesion surface of the first flow-path substrate 107. It is preferable that the size of the base material for transfer is equal to or larger than that of the first flow-path substrate 107. As the base material for transfer, silicon, glass, a film of PET, PEN, PI, or the like can be preferably used. Further, as a method of directly forming the adhesive 110 on the first flow-path substrate 107, screen printing or dispense coating can be cited. It is to be noted that, in the First Embodiment, the adhesive 110 is applied to the first flow-path substrate 107 as an example, but the adhesive 110 may be applied to the second flow-path substrate 113.

Subsequently, the second ashing step of ashing the surface of the substrate 119 on which the energy generating element 102 is formed, that is, the first surface 107a of the first flow-path substrate 107 is performed. FIG. 3F shows the substrate 119 which was ashed. The second ashing step can be performed similarly to the first ashing step. In the second ashing step, the second protective film 120 formed on the first surface 107a is converted into SiO. The part of the second protective film 120 made into SiO is referred to as the second protective film 121.

Subsequently, a second film removing step of removing the SiO second protective film 121 on the first surface 107a is performed. FIG. 3G shows the substrate 119 from which the SiO second protective film 121 has been removed.

As a method of removing the SiO second protective film 121, a wet processing using hydrofluoric acid or a dry etching using F gas can be cited. In the dry etching, the wet processing using hydrofluoric acid is more preferable because there are cases where it is difficult to set a selection ratio between the energy generating element 102 and the protective layer 105. Accordingly, in this example, a hydrofluoric acid processing step of performing a wet processing using hydrofluoric acid is performed as the second film removing step.

Subsequently, a nozzle forming step in which the nozzle forming member 101 is formed on the substrate 119 is performed. By means of the nozzle forming step, the nozzle 101a communicates with the first flow path 116 via the nozzle flow path 101b. Thereafter, a wafer is divided into individual pieces to complete the liquid discharge head substrate 100 as shown in FIG. 2.

Furthermore, as an assembling step, a pitch conversion member in which a pitch conversion channel is formed is connected to the liquid discharge head substrate 100 to obtain the recording element substrate 15, and the electric wiring member 16 is electrically connected to the recording element substrate 15. And the recording element substrate 15, the flow path unit 14, the base member 13, the electric circuit substrate 12, the sub-tank unit 11, and the cover 17 are assembled, and the liquid discharge head 10 is completed.

As described above, in the First Embodiment, the first substrate preparing step, the first film forming step, the first ashing step, the second film forming step, the bonding step, the second ashing step, and the hydrofluoric acid processing step are performed in this order. Further, for the second flow-path substrate 113, the second substrate preparing step and the like are performed before the bonding step. Then, a second film forming step, a bonding step, a second ashing step, and a hydrofluoric acid processing step are performed in this order and thus, it is possible to suppress contamination of the surface of the second protective film, which is brought into close contact with another substrate via an adhesive. And then, the liquid discharge head having high reliability can be manufactured.

It is to be noted that the above-described manufacturing method is merely an example, and steps may be added as appropriate. Needless to say, however, between the first ashing step of the first flow-path substrate 107 shown in FIG. 3D and the bonding step of bonding the first flow-path substrate 107 and the second flow-path substrate 113 shown in FIG. 3E, a step which would cause organic contamination on the bonding surface should not be added.

### Second Embodiment

Subsequently, a Second Embodiment according to this disclosure will be described. The Second Embodiment is different from the First Embodiment in the manufacturing method of a liquid discharge head substrate. Only the configurations of the Second Embodiment that are different from those in the First Embodiment will be described hereinafter. Configurations in the Second Embodiment that are similar to those in the First Embodiment will be given the same reference signs, and description thereof will be omitted.

### Method of Manufacturing Liquid Discharge Head Substrate

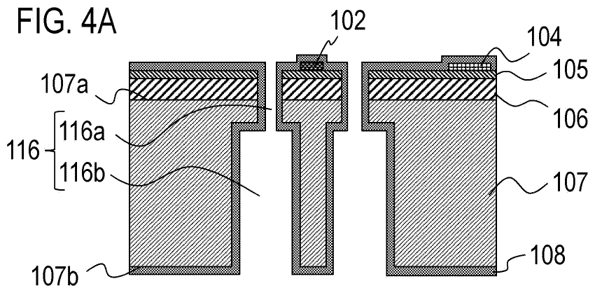

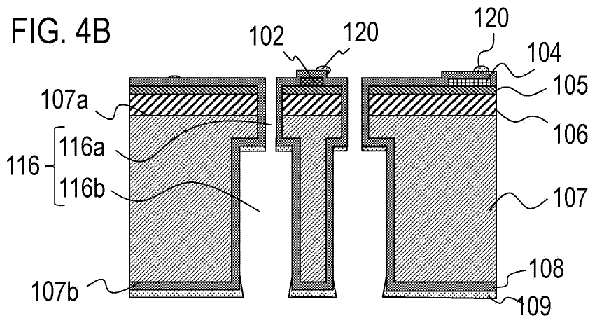

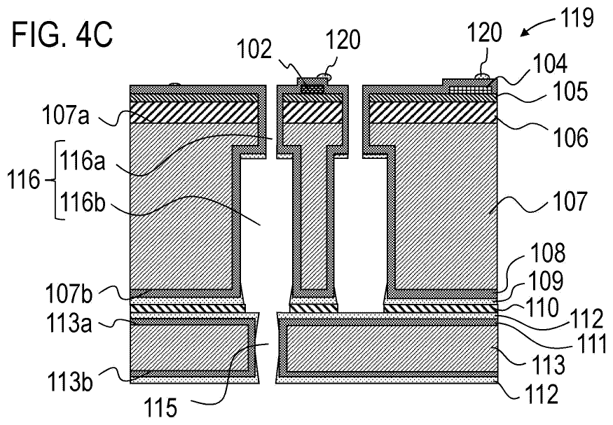

A manufacturing method of a liquid discharge head substrate 100 according to the Second Embodiment will be described in an exemplary manner with reference to FIGS. 4A to 4C. FIGS. 4A to 4C are explanatory diagrams of a method of manufacturing the liquid discharge head substrate 100 and are schematic cross-sectional diagrams in a cross-section similar to FIG. 2.

First, similarly to the First Embodiment, a first substrate preparing step is performed, the wiring layer 106 and the protective layer 105 are laminated, the energy generating element 102 and the electrical connection portion 104 are provided, and the first flow-path substrate 107, in which the first flow path 116 is formed, is prepared. Then, similarly to the First Embodiment, the first film forming step of forming the first protective film 108 on the first flow-path substrate 107 is performed. The type and method of forming the first protective film 108 are similar to those in the First Embodiment. FIG. 4A shows the first flow-path substrate 107 after forming the first protective film 108 according to the Second Embodiment.

It is to be noted that, in this example, the first flow path 116 is formed before the bonding step (bonding of the first flow-path substrate 107 and the second flow-path substrate 113), which will be described later, but it is also possible to form the first flow path 116 by processing the first flow-path substrate 107 after the bonding step. That is, the first substrate preparing step may not include the step of forming the flow path, and the first flow-path forming step of forming the first flow path 116 may be separated from the first substrate preparing step.

Subsequently, as the second film forming step, a second protective film 109 is formed on the first flow-path substrate 107. FIG. 4B shows the first flow-path substrate 107 after forming the second protective film 109 according to the Second Embodiment. The second protective film 109 is formed on the first protective film 108 on the second surface 107b of the first flow-path substrate 107. The type and forming method of the second protective film 109 are similar to those in the First Embodiment. When the first flow path 116 is formed in the first flow-path substrate 107 in advance, in the second film forming step, the second protective film 120 is slightly formed also on the first protective film 108 on the first surface 107a via the first flow path 116.

In the Second Embodiment, similarly to in the First Embodiment, the step of forming the second flow-path substrate 113 is performed in parallel with the various steps for forming the first flow-path substrate 107. It is to be noted that, in this example, the second flow-path forming step of forming the second flow path 115 in the second flow-path substrate 113 may be performed after the bonding step similarly to the first flow-path substrate 107. That is, the second flow-path forming step may be performed separately from the second substrate preparing step.

Subsequently, the bonding step of bonding the first flow-path substrate 107 and the second flow-path substrate 113 is performed. The bonding step is performed similarly to the First Embodiment, and the substrate 119 formed by bonding the second surface 107b of the first flow-path substrate 107 and the third surface 113a of the second flow-path substrate 113 is obtained. FIG. 4C shows the substrate 119 after the bonding step according to the Second Embodiment.

Subsequently, a first film removing step of removing a part of the first protective film 108 is performed. In the first film removing step, in the first protective film 108 formed on the first surface 107a of the first flow-path substrate 107, at least portions corresponding to the region in which the energy generating element 102 and the electrical connection portion 104 are formed and the portions corresponding to the region in which the nozzle forming member 101 is provided later are removed. The first film removing step can be performed similarly to the first film removing step in the First Embodiment.

In the Second Embodiment, by means of the first film removing step, the second protective film 120 on the first protective film 108 is also removed together with the first protective film 108 on the first surface 107a. That is, in the Second Embodiment, the first film removing step can remove (lift off) the second protective film 120 adhering to the first surface 107a together with the first protective film 108 in the second film forming step. After the first film removing step, the substrate 119 is similar to the substrate 119 of the First Embodiment shown in FIG. 3G.

After the first film removing step, the nozzle forming step and the assembling step similar to those in the First Embodiment are performed, and the liquid discharge head substrate 100 and the liquid discharge head 10 are completed.

As described above, in the Second Embodiment, the first substrate preparing step, the first film forming step, the second film forming step, the bonding step, and the first film removing step are performed in this order. Further, with respect to the second flow-path substrate 113, the second substrate preparing step and the like are performed before the bonding step. And by performing the second film forming step and the first film removing step in this order, contamination of the surface of the second protective film that is brought into close contact with another substrate via the adhesive can be suppressed. As a result, the liquid discharge head having high reliability can be manufactured.

It is to be noted that the above-described manufacturing method is merely an example, and additional steps can be appropriately added and the order of steps can be changed. For example, in a case where the flow path is formed after bonding the substrate, the second protective film 109 or the like for improving the adhesion may be formed before bonding the substrate, and the first protective film 108 or the like for protecting the flow path may be formed after the flow path is formed after bonding the substrate. Then, by performing the first film removing step of removing the first protective film 108 on the first surface 107a after that, the second protective film 109 formed on the first surface 107a can be removed together with the first protective film 108. Further, for example, the nozzle forming step of forming the nozzle forming member 101 may be performed before the first film forming step instead of after the bonding step.

### First Example

Subsequently, examples in which a substrate is actually manufactured by using a manufacturing method of the liquid discharge head substrate 100 according to each of the above-described Embodiments will be explained as examples. First, a first example in which the liquid discharge head 10 is manufactured by using the manufacturing method in accordance with the First Embodiment will be explained.

First, as the first substrate preparing step, the protective layer 105 made of SiCN and the wiring layer 106 were laminated on the first flow-path substrate 107 to form the energy generating element 102 made of TaSiN and the electrical connection portion 104 made of Au. Then, the first flow path 116 was formed inside the first flow-path substrate 107 by reactive ion etching using the Bosch process.

Subsequently, as the first film forming step, the first protective film 108 was formed on the first flow-path substrate 107. In this example, TiO was formed as the first protective film 108 by ALD using TiCl₄. In this example, the thickness of the first protective film 108 was set to 30 nm. The structure of the first flow-path substrate 107 after the first film forming step is similar to that shown in FIG. 3A.

Subsequently, as the first film removing step, a dry film resist spin-coated on the film was transferred to the first surface 107a of the first flow-path substrate 107. Then, exposure and development were performed so that the energy generating element 102, the electrical connection portion 104, and the close contact region of the nozzle forming member 101 formed on the first surface 107a were exposed, respectively. After that, the first protective film 108 (TiO) on the first surface 107a of the first flow-path substrate 107 was etched by buffered hydrofluoric acid, and an unnecessary resist was removed by a peeling solution. By means of the first film removing step as above, the first protective film 108 on the first surface 107a was selectively removed, while the organic contaminant 130 remained in the first protective film 108 on the second surface 107b. The structure of the first flow-path substrate 107 after the first film removing step is similar to that shown in FIG. 3B.

Subsequently, as the first ashing step, oxygen ashing was performed on the second surface 107b of the first flow-path substrate 107. The ashing conditions were set to a processing temperature of 225° C., an RF bias 0 W, and a treatment time 135 s. By means of the ashing processing, all the organic contaminants 130 remaining on the second surface 107b could be removed. Further, the chlorine composition ratio in the first protective film 108 (TiO) on the second surface 107 b was lowered from 1.5% to 0.8% by the ashing processing, and the resistance to ink could be improved. The structure of the first flow-path substrate 107 after the first ashing step is similar to that shown in FIG. 3C.

Subsequently, as the second film forming step, the second protective film 109 was formed on the second surface 107b of the first flow-path substrate 107. In this example, the second protective film 109 was formed of SiC by a plasma CVD method. By means of the second film forming step, the second protective film 120 was also formed on the energy generating elements 102 and the electrical connection portion 104, and a close contact region of the nozzle forming member 101 of the first surface 107a via the first flow path 116. The structure of the first flow-path substrate 107 after the second film forming step is similar to that shown in FIG. 3D.

Further, the second flow-path substrate 113 was formed in parallel with the first flow-path substrate 107. The second flow-path substrate 113 was formed by performing the second substrate preparing step, the first film forming step, and the second film forming step.

Subsequently, as the bonding step, an adhesive 110 spin-coated in a film state was brought into contact, while the second surface 107b of the first flow-path substrate 107 was heated to form the adhesive 110 only on the second surface 107b. Benzocyclobutene was used as the adhesive 110. Then, the first flow-path substrate 107 and the second flow-path substrate 113 were bonded to each other and thermally cured to manufacture the substrate 119. The structure of the substrate 119 after the bonding step is similar to that shown in FIG. 3E.

Subsequently, as the second ashing step, oxygen ashing was performed on the first surface 107a of the substrate 119. The ashing conditions were set to a processing temperature of 225° C., an RF bias 0 W, and a processing time 68 s. By performing ashing processing, SiC, which is the second protective film 120 formed on the first surface 107a, was converted into SiO. The structure of the substrate 119 after the second ashing step is similar to that shown in FIG. 3F.

Subsequently, as a second film removing step (hydrofluoric acid processing step), the SiO second protective film 121 on the first surface 107a was removed by using buffered hydrofluoric acid. The processing time of the hydrofluoric acid processing was set to 60s. The structure of the substrate 119 after the second film removing step is similar to that shown in FIG. 3G.

Subsequently, as a nozzle forming step, the nozzle forming member 101 was formed on the first surface 107a of the substrate 119. Then, after the substrate 119 was divided into individual chips, a pitch converting member was connected to the liquid discharge head substrate 100 to obtain the recording element substrate 15. Then, as an assembling step, the recording element substrate 15, the flow path unit 14, the base member 13, the electric circuit substrate 12, the sub-tank unit 11, and the cover 17 are assembled, and the electric wiring member 16 and the electrical connection member 18 are connected, thereby completing the liquid discharge head 10.

### Second Example

Subsequently, a second example in which the liquid discharge head 10 is manufactured by using a manufacturing method according to the Second Embodiment will be described.

First, as a first substrate preparing step, the protective layer 105 made of SiCN and the wiring layer 106 were laminated on the first flow-path substrate 107 to form the energy generating element 102 made of TaSiN and the electrical connection portion 104 made of Au. Then, the first flow path 116 was formed inside the first flow-path substrate 107 by the reactive ion etching using the Bosch process.

Subsequently, as the first film forming step, the first protective film 108 was formed on the first flow-path substrate 107. In this example, TiO was formed as the first protective film 108 by ALD using TiCl₄. In this example, the thickness of the first protective film 108 was set to 30 nm. The structure of the first flow-path substrate 107 after the first film forming step is similar to that shown in FIG. 4A.

Subsequently, as the second film forming step, the second protective film 109 was formed on the second surface 107b of the first flow-path substrate 107. In this example, the second protective film 109 was formed of SiC by the plasma CVD method. By means of the second film forming step, the second protective film 120 was formed also on the first protective film 108 on the first surface 107a via the first flow path 116. The structure of the first flow-path substrate 107 after the second film forming step is similar to that shown in FIG. 4B.

Further, the second flow-path substrate 113 was formed in parallel with the first flow-path substrate 107. The second flow-path substrate 113 was formed by performing the second substrate preparing step, the first film forming step, and the second film forming step.

Subsequently, as the bonding step, the adhesive 110 spin-coated in the film state was brought into contact, while the second surface 107b of the first flow-path substrate 107 was heated to form the adhesive 110 only on the second surface 107b. Benzocyclobutene was used as the adhesive 110. Then, the first flow-path substrate 107 and the second flow-path substrate 113 are bonded to each other and thermally cured to manufacture the substrate 119. The structure of the substrate 119 after the bonding step is similar to that shown in FIG. 4C.

Subsequently, as the first film removing step, a dry film resist spin-coated on the film was transferred to the first surface 107a of the first flow-path substrate 107. Then, exposure and development were performed so that the energy generating element 102, the electrical connection portion 104, and the close contact region of the nozzle forming member 101 formed on the first surface 107a were exposed, respectively. After that, the first protective film 108 (TiO) on the first surface 107a of the first flow-path substrate 107 was etched by buffered hydrofluoric acid, and an unnecessary resist was removed by a peeling solution. At this time, the second protective film 120 (SiO) on the first protective film 108 was lifted off and removed by etching the first protective film 108 (TiO). The structure of the substrate 119 after the first film removing step is similar to that shown in FIG. 3G.

Subsequently, as a nozzle forming step, the nozzle forming member 101 was formed on the first surface 107a of the substrate 119. Then, after the substrate 119 was divided into individual chips, a pitch converting member was connected to the liquid discharge head substrate 100 to obtain the recording element substrate 15. Then, as an assembling step, the recording element substrate 15, the flow path unit 14, the base member 13, the electric circuit substrate 12, the sub-tank unit 11, and the cover 17 were assembled, and the electric wiring member 16 and the electrical connection member 18 were connected, thereby completing the liquid discharge head 10.

According to this disclosure, a liquid discharge head with high reliability can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-215846, filed Dec. 10, 2024, which is hereby incorporated by reference herein in its entirety.

What is claimed is:

1. A method of manufacturing a liquid discharge head comprising a first flow-path substrate and a second flow-path substrate, including:
(a) a first substrate preparing step of providing an energy generating element for generating energy for discharging a liquid on a first surface of the first flow-path substrate and of forming a first flow path passing through from the first surface to a second surface opposite to the first surface in the first flow-path substrate;
(b) a second substrate preparing step of forming a second flow path passing through from a third surface to a fourth surface opposite to the third surface in the second flow-path substrate;
(c) a first film forming step of forming a first protective film covering at least a part of the first surface of the first flow-path substrate and a wall surface of the first flow path;
(d) a first ashing step of ashing the second surface of the first flow-path substrate;
(e) a second film forming step of forming a second protective film covering the second surface of the first flow-path substrate;
(f) a bonding step of bonding the second surface of the first flow-path substrate and the third surface of the second flow-path substrate via an adhesive such that the first flow path and the second flow path communicate with each other;
(g) a second ashing step of ashing the first surface of the first flow-path substrate; and
(h) a hydrofluoric acid processing step of processing the first surface of the first flow-path substrate with hydrofluoric acid, wherein
the second film forming step, the bonding step, the second ashing step, and the hydrofluoric acid processing step are performed in this order.

2. The method of manufacturing a liquid discharge head according to claim 1, wherein
the first substrate preparing step, the first film forming step, the first ashing step, and the second film forming step are performed in this order.

3. The method of manufacturing a liquid discharge head according to claim 1, wherein
the first protective film is formed of TiO.

4. The method of manufacturing a liquid discharge head according to claim 1, wherein
the second protective film is formed by including at least any one of SiC, SiCN, SiOC, and SiOCN.

5. The method of manufacturing a liquid discharge head according to claim 1, wherein
the first film forming step is a step of forming the first protective film by an atomic layer deposition method.

6. The method of manufacturing a liquid discharge head according to claim 1, wherein
the second film forming step is a step of forming the second protective film by a plasma CVD method.

7. A method of manufacturing a liquid discharge head comprising a first flow-path substrate and a second flow-path substrate including:
(a) a first substrate preparing step of providing an energy generating element for generating energy for discharging a liquid on a first surface of the first flow-path substrate;
(b) a first film forming step of forming a first protective film covering at least a part of the first surface of the first flow-path substrate;
(c) a second film forming step of forming a second protective film covering a second surface opposite to the first surface of the first flow-path substrate;
(d) a bonding step of bonding the second surface of the first flow-path substrate and a third surface of the second flow-path substrate via an adhesive; and
(e) a first film removing step of removing at least a part of the first protective film provided on the first surface of the first flow-path substrate, wherein
the second film forming step and the first film removing step are performed in this order.

8. The method of manufacturing a liquid discharge head according to claim 7, wherein
the first substrate preparing step, the first film forming step, the second film forming step, the bonding step, and the first film removing step are performed in this order.

9. The method for manufacturing a liquid discharge head according to claim 7, further comprising:
(f) a first flow-path forming step of forming a first flow path in the first flow-path substrate; and
(g) a second flow-path forming step of forming a second flow path in the second flow path substrate, wherein
the first flow-path forming step and the second flow-path forming step are performed before the bonding step.

10. The method of manufacturing a liquid discharge head according to claim 7, wherein
the first protective film is formed of TiO.

11. The method of manufacturing a liquid discharge head according to claim 7, wherein
the second protective film is formed by including at least any one of SiC, SiCN, SiOC, and SiOCN.

12. The method of manufacturing a liquid discharge head according to claim 7, wherein
the first film forming step is a step of forming the first protective film by an atomic layer deposition method.

13. The method of manufacturing a liquid discharge head according to claim 7, wherein
the second film forming step is a step of forming the second protective film by plasma CVD method.

14. The method of manufacturing a liquid discharge head according to claim 1, wherein
the first protective film is formed of TiO; and
the first ashing step is a step in which an organic substance is removed by oxygen ashing.

15. A liquid discharge head, comprising:
a first flow-path substrate; and
a second flow-path substrate, wherein
the liquid discharge head is manufactured by a manufacturing method, comprising:
(a) a first substrate preparing step of providing an energy generating element for generating energy for discharging a liquid on a first surface of the first flow-path substrate and forming a first flow path passing through from the first surface to a second surface opposite to the first surface in the first flow-path substrate;
(b) a second substrate preparing step of forming a second flow path passing through from a third surface to a fourth surface opposite to the third surface in the second flow-path substrate;
(c) a first film forming step of forming a first protective film covering at least a part of the first surface of the first flow-path substrate and a wall surface of the first flow path;
(d) a first ashing step of ashing the second surface of the first flow-path substrate;
(e) a second film forming step of forming a second protective film covering the second surface of the first flow-path substrate;
(f) a bonding step of bonding the second surface of the first flow-path substrate and the third surface of the second flow-path substrate via an adhesive such that the first flow path and the second flow path communicate with each other;
(g) a second ashing step of ashing the first surface of the first flow-path substrate; and
(h) a hydrofluoric acid processing step of processing the first surface of the first flow-path substrate with hydrofluoric acid, wherein
the second film forming step, the bonding step, the second ashing step, and the hydrofluoric acid processing step are performed in this order; and
a chlorine composition ratio of the first protective film is 1% or less.
